(19) United States
(12) Patent Application Publication
(10) Pub. No.: US 2014/0154506 A1
(43) Pub. Date: Jun. 5, 2014

(54) PRESSURE SENSITIVE ADHESIVES PREPARED FROM MALEATED VEGETABLE OILS AND EXPOXIDIZED VEGETABLE OILS

(71) Applicant: Avery Dennison Corporation, Pasadena, CA (US)

(72) Inventors: Charles R. WILLIAMS, Lock Haven, PA (US); Qiang LUO, State College, PA (US); Mark GOWER, Mill Hall, PA (US)

(73) Assignee: Avery Dennison Corporation, Pasadena, CA (US)

(21) Appl. No.: 14/098,148

(22) Filed: Dec. 5, 2013

Related U.S. Application Data
(60) Provisional application No. 61/733,816, filed on Dec. 5, 2012.

(51) Int. Cl. C09J 191/00; C09J 7/02

(52) U.S. Cl. CPC C09J 191/00; C09J 7/0207
USPC 428/355 R; 554/121; 106/287.24; 554/122

(57) ABSTRACT

A method that includes reacting an epoxidized naturally-occurring oil or fat with a triacid to form a pressure sensitive adhesive or a pressure sensitive adhesive precursor is disclosed. The present invention also includes methods for preparing a triacid and for preparing a pressure sensitive adhesive label or tape.

### CROSS-REFERENCE TO RELATED APPLICATION

The present application claims the benefit of U.S. Provisional Application No. 61/733,816 filed Dec. 5, 2012, which is incorporated herein by reference in its entirety.

### BACKGROUND OF THE INVENTION

The present invention relates generally to the field of pressure sensitive adhesives (PSAs). More specifically, the invention relates to pressure sensitive adhesives that are formed from renewable resources and methods for forming such pressure sensitive adhesives.

### SUMMARY OF THE INVENTION

In one embodiment, the present invention includes a method for forming a pressure sensitive adhesive. The method includes combining one or more epoxidized naturally-occurring oils or fats with at least one triacid to form a reaction mixture, and applying heat to the reaction mixture to form pressure sensitive adhesive.

In another embodiment, the present invention comprises a pressure sensitive adhesive label or tape. The label or tape may include a face stock and a layer of pressure sensitive adhesive. At least a portion of the pressure sensitive adhesive is prepared is produced by combining one or more epoxidized naturally-occurring oils or fats with at least one triacid to form a reaction mixture and applying heat to the reaction mixture to form pressure sensitive adhesive.

In still another embodiment, the present invention includes a pressure sensitive adhesive label or tape. The label or tape includes a facestock and a pressure sensitive adhesive composition disposed on the facestock. In addition, at least a portion of the pressure sensitive adhesive composition includes a composition prepared from reacting an epoxidized naturally-occurring oil or fat with a triacid.

In a further embodiment, the present invention includes a pressure sensitive adhesive label or tape. The label or tape includes a facestock with an upper face and a lower face and one or more layers of adhesive disposed on the lower face of the facestock. In addition, at least a portion of one layer of the adhesive includes a composition made from reacting an epoxidized naturally-occurring oil or fat with a triacid.

In an additional embodiment, the present invention also includes a method for forming a triacid. The method includes mixing a naturally-occurring oil or fat having at least three hydroxyl groups with an anhydride to form an acid formation mixture. The method further includes heating the acid formation mixture to form a triacid.

The following description and drawings, which are incorporated in and constitute a part of this specification, illustrate one or more embodiments of the invention and, serve to explain the principles and exemplary embodiment of the invention.

### BRIEF DESCRIPTION OF THE DRAWINGS

FIG. 1 is a flow chart illustrating an exemplary process involving a pressure sensitive adhesive precursor;

FIG. 2 is a flow chart illustrating an exemplary process of one embodiment of the invention;

FIG. 3 is a graph showing a comparison of testing data according for different catalysts; and

FIG. 4 is a graph showing comparison of testing data for two catalysts.

### DETAILED DESCRIPTION OF EXEMPLARY EMBODIMENTS

Reference will now be made in detail to exemplary embodiments of the present invention, one or more examples of which are illustrated in the accompanying drawings. Each example is provided by way of explanation of the invention and not by limitation of the invention. It will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

The terms “naturally-occurring” or “natural” fats and/or oils as used herein generally refer to fats or oils that are obtained from plants, algae, or animals as opposed to such materials obtained from petroleum or other fossil fuels. Thus, the terms “naturally-occurring” or “natural” exclude oils or other materials that are obtained either directly or indirectly from petroleum sources or fossil fuel sources. As will be appreciated, examples of fossil fuels include coal, petroleum based oil, and gas. The natural fats and/or oils referred to herein include fats and/or oils that are obtained from plants, algae or animals and also to such fats and/or oils which have been subjected to various purification, processing, or chemical reactions.

By way of example, and without limitation, natural fats and oils from plant, algae, or animal sources may include soybean oil, palm oil, olive oil, corn oil, canola oil, linseed oil, rapeseed oil, castor oil, coconut oil, cottonseed oil, palm kernel oil, rice bran oil, safflower oil, sesame oil, sunflower oil, tall oil, lard, tallow, fish oil, and combinations thereof. Typically, the fatty acids associated with natural fats and oils include long chain, e.g. C₈ to C₂₂, moieties, many of which include multiple double bonds per chain. The glycerol molecule has three hydroxyl (OH—) groups. Each fatty acid has a carboxyl group (COOH—). In triglycerides, the hydroxyl groups of the glycerol join the carboxyl groups of the fatty acids to form ester bonds.

The term “bio-based” as used herein refers to such agents that are obtained from naturally occurring fats and/or oils.

The term “renewable resource” refers to natural resources with the ability of being replaced through biological or other natural processes and replenished with the passage of time.

Throughout the disclosure, the terms “fat”, “oil” and other reagents are referred to in singular and plural forms interchangeably, unless otherwise specified. It should be understood that the reference to each reagent also includes other components, mixtures, and/or impurities that exist naturally with such reagent or as a result of the process to obtain such reagents.

In various embodiments of the present invention, pressure sensitive adhesives may be produced from one or more naturally-occurring fats and/or oils. In some embodiments, natural fats or oils may be epoxidized and reacted with one or more triacids to produce pressure sensitive adhesives. In some embodiments, such triacids may themselves be formed from naturally-occurring oils or fats. In other embodiments of the invention, triacids may be produced from bio-based triglycerides having one or more hydroxyl groups or other naturally-occurring compounds having a hydroxyl group. By way of further illustration, various exemplary embodiments of the invention are provided below.

As indicated above, the present invention includes embodiments in which triacids may be reacted with an epoxidized vegetable oil to produce a pressure sensitive adhesive. As used herein, the term triacid means a trifunctional acid having three reaction sites, wherein the functionality of a trifunctional acid is in the range of about 2.0 to about 3.0. In some embodiments, triacids of the present invention may have a functionality of about 2.5 to about 3.0. As used herein, triacids further include acids with a functionality of about 2.5 to about 2.9.

By way of example, and without limitation, a triacid within the scope of the present invention may be prepared in the following manner:

Compound with Three Hydroxyl Groups+Anhydride→Triacid

As indicated above, the present invention includes embodiments using a naturally-occurring compound having three hydroxyl groups, such as a vegetable oil with three hydroxyl groups, to form a triacid. The ratio of the tri-hydroxyl compound to anhydride in the foregoing reaction may be in the range of about 2.5:1 to about 3:1. In some embodiments, the reaction may be mixed at a temperature of about room temperature to about 200° C. and the cooking time may range from about 2 hours to about 72 hours. In other embodiments, the mixture may be heated at a temperature in the range of about 80° C. to about 140° C. In some embodiments, the cooking time may range of about 4 to about 8 hours. In still another embodiment, the reaction may be conducted while stirring the mixture at a temperature in the range of about 90° C. to about 130° C. for about 7 hours to about 8 hours. Toluene may also be added to the reaction mixture in an amount from about 10 grams to about 100 grams. Ultimately, the reaction temperature and cooking time may be varied to alter the functionality of the resulting triacid.

Any anhydride may be used to form a triacid as contemplated within the present invention. By way of example, and without limitation, anhydrides such as maleic anhydride, phenyl maleic anhydride, methyl maleic anhydride, succinic anhydride, phenyl succinic anhydride, methyl succinic anhydride, glutaric anhydride, phthalic anhydride, naphthalic anhydride, citraconic anhydride, itaconic anhydride, and homophthalic anhydride, monomaleated triglyceride may be used in various embodiments of the present invention to prepare a triacid.

In one particular embodiment, the following reaction of castor oil and maleic anhydride using the conditions discussed above is exemplary of an embodiment of preparing a triacid within the scope of the present invention:

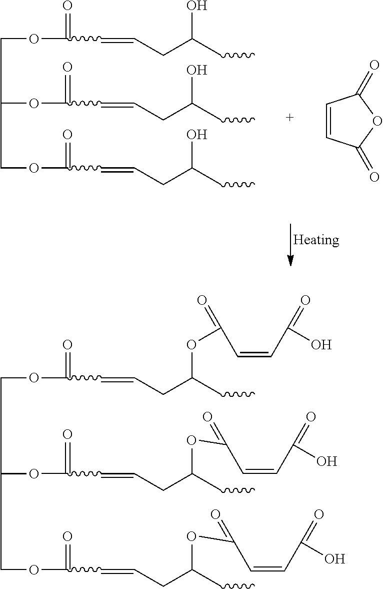

As shown above, the resulting product is castor oil triacid, or COTA, which is a maleic anhydride of castor oil and serves as a multifunctional carboxylic acid with a functionality in the range of about 2 and about 3. In some embodiments, the functionality of the resulting COTA acid is about 2.5 to about 2.9.

The following examples further illustrate the formation of a triacid as contemplated by exemplary embodiments of the present invention:

### Example 1

Maleic anhydride (MA) and castor oil were added, at a mole ratio of 3:1, to a 500 mL four-necked reactor equipped with heating jacket, a stirrer, a thermometer, a condenser, and an inlet of dry nitrogen. 90 grams of toluene were added. The reaction proceeded with continuous stirring at a temperature of about 90° C. for a time period of about 7 hours. After cooling down to 50° C., the reaction mixture was mixed with about 10 wt % HCl solution. The mixture was then stirred at room temperature overnight. The resulting two phases were then separated with a separation funnel. After washing with deionized water 4 times, the organic layer phase was dried with anhydrous MgSO₄. The solid was then separated and the filtrate was transported into a rotary evaporator and placed under a vacuum of 10 mbar for about 6 hours. The viscous yellowish COTA was then saved in a 1 liter jar for further use.

### Example 2

Maleic anhydride (MA) and castor oil were added, at a molar ratio of 3:1, to a 500 mL four-necked reactor equipped with heating jacket, a stirrer, a thermometer, a condenser, and an inlet of dry nitrogen. 22 grams of toluene grams were added. The reaction proceeded with continuous stirring at a temperature of about 130° C. for a period of time of about 7 hours 45 minutes. After cooling down to 50° C., the reaction mixture was diluted with ethyl acetate and was mixed with about 10 wt % HCl solution. The mixture was then stirred at room temperature overnight. The resulting two phases were then separated with a separation funnel. After washing with deionized water 4 times, the organic layer phase was dried with anhydrous MgSO₄. The solid was then separated and the filtrate was transported into a rotary evaporator and placed under a vacuum of 10 mbar for about 6 hours. The viscous yellowish COTA was then saved in a 1 liter jar for further use.

### Example 3

Maleic anhydride (MA) and castor oil were added, at a molar ratio of 2.5:1, to a 500 mL four-necked reactor equipped with heating jacket, a stirrer, a thermometer, a condenser, and an inlet of dry nitrogen. 10 grams of toluene of 10 grams were added. The reaction proceeded with continuous stirring at a temperature of about 130° C. for a period of time of about 7 hours 48 minutes. After cooling down to 50° C., the reaction mixture was diluted with ethyl acetate and was mixed with about 10 wt % HCl solution. The mixture was then stirred at room temperature overnight. The resulting two phases were then separated with a separation funnel. After washing with deionized water 4 times, the organic layer phase was dried with anhydrous MgSO₄. The solid was then separated and the filtrate was transported into a rotary evaporator and placed under a vacuum of 10 mbar for about 6 hours. The viscous yellowish COTA was then saved in a 1 liter jar for further use.

The present invention also includes heating a mixture of a triacid, including triacids prepared from naturally-occurring compounds, and compounds having an epoxy group, such as expoxidized bio-based or naturally-occurring compounds, to produce a pressure sensitive adhesive. In some embodiments of the present invention, the ratio of triacid to expoxidized compound may be in the range of about 1:1 to about 5.5:1, including each intermittent ratio therein. In some embodiments, the ratio may be in the range of about 3.5:1 to about 5.0:1. In other embodiments, the ratio may be about 4.5:1.

In some embodiments, epoxidized vegetable oils may be reacted with a triacid to create a pressure sensitive adhesive. Epoxidized vegetable oils may include any derivative of vegetable oils whose double bonds are fully or partly epoxidized using any method, such as an in situ performic acid process. Epoxidized vegetable oils are commercially available or may be formed by converting at least a portion of a vegetable oil's double bonds into oxirane moieties. By way of example, epoxidized vegetable oils may include epoxidized triglycerides, epoxidized diglycerides, epoxidized monoglycerides, and partially epoxidized equivalents. Examples of commercially-available epoxidized soybean oil and its derivatives include, DEHYSOL available from Cognis/BASF, VIKOFLEX available from Arkema, and DRAPEX available from Galata Chemicals. In addition to epoxidized soybean oil, epoxidized palm oil, epoxidized corn oil, epoxidized linseed oil, and others are available commercially and are contemplated as useful in conjunction with the present invention.

As an alternative to commercially-available epoxidized compounds, epoxidized compounds may be prepared from naturally-occurring fats or oils. By way of example, one or more naturally-occurring fats or oils may be subjected to a reaction whereby epoxide functional groups are introduced into the triglycerides, diglycerides, and/or mono-glycerides of the fats or oils by epoxidation of the double bonds in the glycerides.

In one particular embodiment, castor oil triacid, as discussed above, may be reacted with epoxidized soybean oil to form a pressure sensitive acid as shown below:

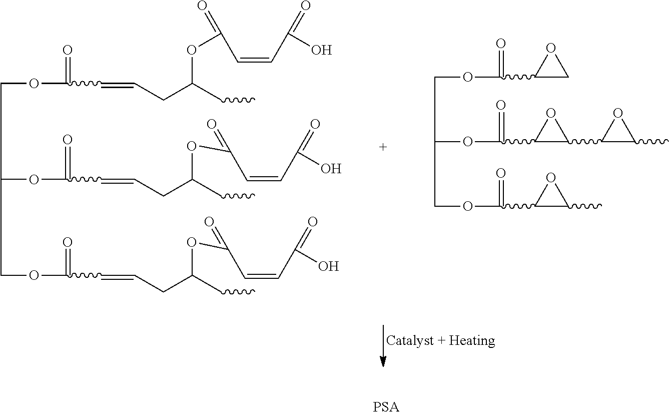

In preparing an embodiment of a pressure sensitive adhesive of the present invention, one or more triacids and one or more epoxidized compounds may be mixed, stirred, and heated. In one embodiment of the invention, the reaction is performed in a reactor and at conditions sufficient to achieve a conversion of the reactants to a coatable syrup, which is a flowable viscous material. In some embodiments, heating may take place at temperatures in the range of about 60° C. to about 120° C., including each intermittent value therein. In other embodiments, a temperature equal to or less than 100° C. may be used. In still other embodiments, a temperature in the range of about 80° C. to about 100° C. may be used. In one embodiment, a temperature of about 80° C. is employed. In some embodiments, the mixture may be stirred in the reactor for about 30 to about 60 minutes. In some embodiments, the mixture may be heated for about 40 minutes. In addition, the flowable, relatively viscous material obtained from the foregoing reaction may be deposited on a web, such as a release liner, or other suitable member at sufficiently high temperatures in the presence of a catalyst to accelerate the conversion.

In addition, any suitable catalyst may optionally be used to increase the reaction rate in forming a pressure sensitive adhesive of the present invention. Exemplary catalysts that may be used include, but are not limited to, amines, imidazoles, phenols, and metal complexes. Examples include dimethyl benzyl amine (DMBA), triethylamine, triethanolamine, 2-ethyl-4-methylimidazole, 2,4,6-tris(dimethylaminomethyl)phenol, chromium acetylacetonate (CrAA), zinc chloride, and aluminum chloride. Examples of commercially available activated chromium(III) complexes include, but are not limited to, AMC2 from Ampac and HYCAT from Dimension Technology Chemical Systems, Inc. Zinc chelate catalysts are also available from King Industries under the trade name NACURE. The formation of pressure sensitive adhesives in the context of the present invention may also be catalyzed using strong acids (Lewis acids) such as HBF₄. In addition, the reaction materials may be cured using ultraviolet light and utilizing any suitable ultraviolet imitators, such as CPI 6976 Aceto, which is available from Aceto Corp.

In some embodiments, additional additives such as fillers, tackifiers, plasticizers, or bio-based tackifiers or plasticizers may also be added to further modify the properties of the resulting pressure sensitive adhesive.

In addition, other functional group-containing agents, such as sulfonic acids, sulfates, phosphates, and the like, may also be used to incorporate such functional groups into the resulting polymeric network. Similarly, materials containing either the epoxy group or the hydroxyl group may also be used to incorporate an additional type of functionality. Examples of materials that are contemplated as useful include, but are not limited to, hydroxyethylacrylate, hydroxylethylmethacrylate, hydroxypropylacrylate, hydroxypropylmethacrylate, hydroxybutylacrylate, hydroxybutylmethacrylate, glycidylmethacrylate, and combinations thereof.

In preparing the pressure sensitive adhesive, one or more solvents may also be added to the reagents, the reagent mixture, and/or to the resulting polymeric products. A wide array of solvents may be used such as organic solvents. Exemplary organic solvents include, but are not limited to heptane or toluene.

A range of other additives may be added to further modify the adhesive behavior or to improve the processing, coating, or curing of the described bio-based pressure sensitive adhesive. Such additives may enhance the peel behavior on low surface energy substrates, such as polyethylene (PE), polypropylene (PP) and the like. Examples of additives contemplated as useful include, but are not limited to, rosin-based tackifiers such as Foral 85.

Additives may also be used to further improve the curing speed or significantly lower the amount of catalysts for a given cure rate. For example, multifunctional molecules, such as molecules containing more than one hydroxyl, carboxylate, thiol, vinyl ether, silane, siloxane or epoxy functionalities may serve to amplify the crosslinking effect by providing additional crosslinkable sites. Non-limiting examples of such additives include, methyltriethoxysilane, tetraethyl orthosilicate, 1,4-cyclohexanedimethanol diglycidyl ether, pentaerythritol, tetra(ethylene glycol dimethyl ether) and its derivatives. In general, such additives may be used in a concentration of up to about 10% by weight of the starting polymer. Such additives may facilitate the crosslinking by enhancing the generation of photoacids or by providing additional crosslinkable sites.

In addition, in some embodiments, one or both of the triacid and the epoxidized compound used to form a pressure sensitive adhesive may be prepared from naturally-occurring compounds, such as vegetable oils. Although the use of fossil-based components in the formation of the PSAs is generally not preferred in certain embodiments of the present invention, it will be understood that the invention includes the use of such components as additives in order to obtain certain desired properties or characteristics in the resulting network. For example, the invention may include combining the pressure sensitive adhesives described herein, with one or more components that are obtained or produced from nonrenewable resources such as fossil fuel-derived polymers or components. In this regard, pressure sensitive adhesives formed from natural fats and/or oils as described herein can optionally be combined with polymers obtained from nonrenewable resources that contain acrylic or epoxide functionality or other pendant groups to selectively adjust or control the properties of the resulting material. A non-limiting example of such property is crosslink density. Techniques based upon this strategy enable a formulator to specifically tailor and/or adjust the properties and performance characteristics of the end product material. This technique enables particular “balancing” of properties of the resulting material. In one embodiment of the invention, the proportion of material originating from renewable resources is at least 25% and in a further embodiment, at least 75%.

By way of further illustration, the following examples illustrate the preparation of a pressure sensitive adhesive according to exemplary embodiments of the present invention. Each of these examples is considered an independent embodiment of the present invention. In addition, each parameter recited in an embodiment may be utilized in other embodiments.

### Example 4

### COTA/ESO=1/1

A mixture of COTA (6 g), epoxidized soybean oil (ESO) (6 g), and chromium acetylacetonate (Hycat 2000S) (0.132 g) was charged into a 50 ml flask with magnetic stirring. The reactants were heated in an oil bath at 90° C. for 40 minutes. The viscous mixture was then cast onto a 2 mil polyethylene terephthalate (PET) film with a lab coater. The coated material was then further cured in oven at 100° C. for 1 hour. Upon visual inspection and touching, the coating was observed as highly crosslinked and its surface had very low finger tack.

### Example 5

### COTA/ESO=2/1

Mixture of COTA (12 g), ESO (6 g), and Hycat 2000S (0.182 g) were charged into a 50 ml flask with magnetic stirring. The reactants were heated in an oil bath at 90° C. for 40 minutes. The viscous mixture was then cast onto a 2 mil PET film with a lab coater. The coated material was then further cured in oven at 100 Celsius for 1 hour. Upon visual inspection and touching, the coating was observed as highly crosslinked and its surface had very low finger tack.

### Example 6

### COTA/ESO=3/1

A mixture of COTA (9 g), ESO (3 g), and Hycat 2000S (0.141 g) were charged into a 50 ml flask with magnetic stirring. The reactants were heated in an oil bath at 90° C. for 40 minutes. The viscous mixture was then cast onto a 2 mil PET film with a lab coater. The coated material was then further cured in oven at 100° C. for 1 hour. Upon visual inspection and touching, the coating was observed as highly crosslinked and its surface had very low finger tack.

### Example 7

### COTA/ESO=4/1

A mixture of COTA (12 g), ESO (3 g), and Hycat 2000S (0.153 g) were charged into a 50 ml flask with magnetic stirring. The reactants were heated in an oil bath at 90° C. for 40 minutes. The viscous mixture was then cast onto a 2 mil PET film with a lab coater. The coated material was then further cured in oven at 100° C. for 1 hour. Upon visual inspection and touching, the coating was observed as highly crosslinked and its surface had very low finger tack.

### Example 8

### COTA/ESO=4.5/1

A mixture of COTA (9 g), ESO (2 g), and Hycat 2000S (0.118 g) were charged into a 50 ml flask with magnetic stirring. The reactants were heated in an oil bath at 90° C. for 40 minutes. The viscous mixture was then cast onto a 2 mil PET film with a lab coater. The coated material was then further cured in oven at 100° C. for 1 hour. Upon visual inspection and touching, the coating was observed as highly crosslinked and its surface had low finger tack.

### Example 9

### COTA/ESO=5/1

A mixture of COTA (10 g), ESO (2 g), and Hycat 2000S (0.122 g) were charged into a 50 ml flask with magnetic stirring. The reactants were heated in an oil bath at 90° C. for 40 minutes. The viscous mixture was then cast onto a 2 mil PET film with a lab coater. The coated material was then further cured in oven at 100° C. for 1 hour. Upon visual inspection and touching, the coating was observed as highly crosslinked and its surface had good finger tack.

### Example 10

### COTA/ESO=5.2/1

A mixture of COTA (20.8 g), ESO (4 g), and aluminum acetylacetonate (15 wt % solution in toluene, 1.597 g) were charged into a 50 ml flask with magnetic stirring. The reactants were heated in an oil bath at 90° C. for 40 minutes. The viscous mixture was then cast onto a 2 mil PET film with a lab coater. The coated material was then further cured in oven at 100° C. for 1.5 hour. Upon visual inspection and touching, the coating was observed as highly crosslinked and its surface had good finger tack.

### Example 11

### COTA/ESO=5.3/1

A mixture of COTA (15.9 g), ESO (3 g), and aluminum acetylacetonate (15 wt % solution in toluene, 1.197 g) were charged into a 50 ml flask with magnetic stirring. The reactants were heated in an oil bath at 90° C. for 40 minutes. The viscous mixture was then cast onto a 2 mil PET film with a lab coater. The coated material was then further cured in oven at 100° C. for 1.5 hour. Upon visual inspection and touching, the coating was observed as highly crosslinked and its surface had good finger tack.

### Example 12

### COTA/ESO=5.4/1

A mixture of COTA (16.2 g), ESO (3 g), and aluminum acetylacetonate (15 wt % solution in toluene, 1.280 g) were charged into a 50 ml flask with magnetic stirring. The reactants were heated in an oil bath at 90° C. for 40 minutes. The viscous mixture was then cast onto a 2 mil PET film with a lab coater. The coated material was then further cured in oven at 100° C. for 1.5 hour. Upon visual inspection and touching, the coating was observed as highly crosslinked and its surface had good finger tack.

### Example 13

### COTA/ESO=5.5/1

A mixture of COTA (16.5 g), ESO (3 g), and aluminum acetylacetonate (15 wt % solution in toluene, 1.289 g) were charged into a 50 ml flask with magnetic stirring. The reactants were heated in an oil bath at 90° C. for 40 minutes. The viscous mixture was then cast onto a 2 mil PET film with a lab coater. The coated material was then further cured in oven at 100° C. for 1.5 hour. Upon visual inspection and touching, the coating was observed as highly crosslinked and its surface had good finger tack.

### Example 14

### COTA/ESO=6/1

A mixture of COTA (6 g), ESO (1 g), and Hycat 2000S (0.074 g) were charged into a 50 ml flask with magnetic stirring. The reactants were heated in an oil bath at 90° C. for 40 minutes. The viscous mixture was then cast onto a 2 mil PET film with a lab coater. The coated material was then further cured in oven at 100° C. for 1 hour. Upon visual inspection and touching, the coating was observed as highly crosslinked and its surface did not have ample cohesive strength.

### Example 15

### COTA/ESO Prepolymer

COTA (270 g) and Drapex 6.8 (67.5 g) were added in a 500 mL four-necked reactor equipped with heating jacket, a stirrer, a thermometer, and an inlet of dry nitrogen. The reactants were heated to and kept at 80° C. Viscosity of the reaction mixture was monitored using a density meter with 2° 40 mm plate at the same temperature. Heating was stopped when viscosity reached 2,500 cps.

### Example 16

### COTA/ESO Prepolymer

COTA (307 g) and Drapex 6.8 (61.5 g) were added in a 500 mL four-necked reactor equipped with heating jacket, a stirrer, a thermometer, and an inlet of dry nitrogen. The reactants were heated to and kept at 80° C. Viscosity of the reaction mixture was monitored using a density meter with 2° 40 mm plate at the same temperature. Heating was stopped when viscosity reached 4,200 cps.

### Example 17

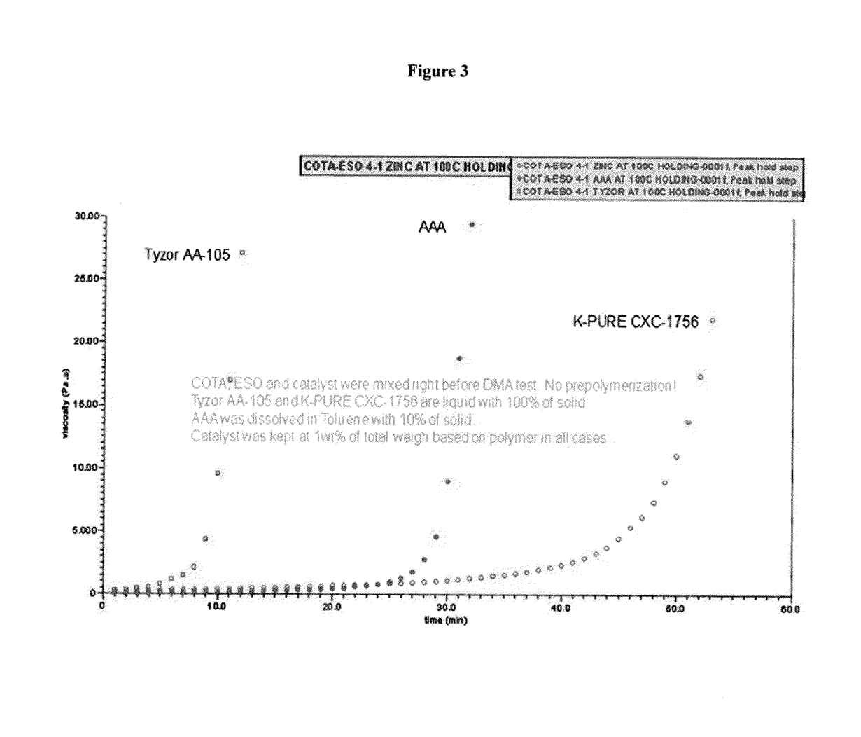

Three mixtures of COTA and epoxidized soybean oil (Drapex 6.8) were prepared at a 4:1 ratio. A catalyst, selected form Tyzor AA105 (previously available from DuPont and currently available from Dorf Ketal), aluminum acetylacetonate in toluene (10 wt %), and K-PURE CXC-1756 (available at King Industries Inc.) at 1 wt % of solid weight, was then added to each mixture. Each mixture was then heated to and held at 100° C. to monitor the evolution of viscosity. The results of this example are presented in FIG. 3.

### Example 18

317 grams of the prepolymer prepared in Example 15 was prepared with a special viscosity of 3000 cps. The prepolymer was then mixed with 3 grams of Tyzor AA-105 just before adding the mixture into a heating pot that had been heated to 70° C. The materials gelled in the die at 80° C. upon coating. As a result, it was concluded that catalysis using Tyzor AA-105 was too fast under the applied conditions such that premature curing occurred.

### Example 19

322 grams of the prepolymer prepared in Example 15 was prepared with a special viscosity of 3000 cps. The prepolymer was then mixed with 3.22 grams of Tyzor AA-105 and 4.44 grams of 2,4-pentanedione right before adding into a heating pot heated to 70° C. The mixture was coated onto PET film with a die at 80° C. The coated material was then passed through a 24-foot oven (two-way) at 40 ft/min. Curing was not finished. The line speed was then decreased to 30 ft/min and curing was not finished either. It was concluded that 2,4-pentanedione overly retarded the catalysis of Tyzor AA-105 under the applied conditions and caused an incomplete curing of the adhesive.

### Example 20

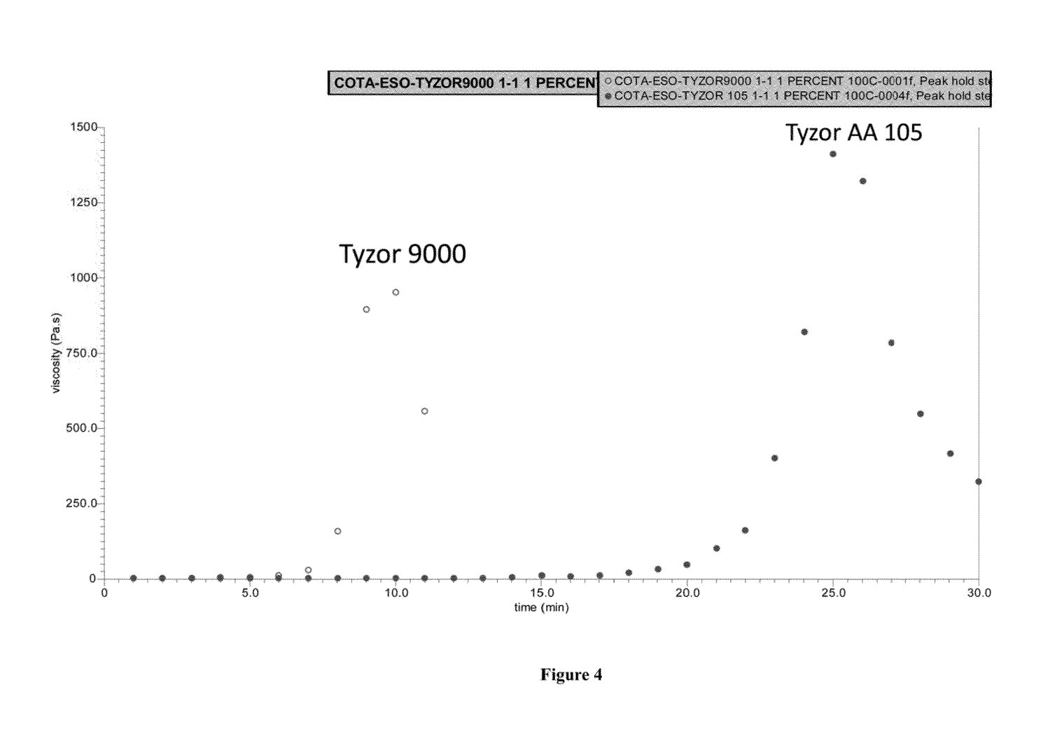

Two mixtures of COTA and epoxidized soybean oil (Drapex 6.8) were prepared at a 1:1 ratio. Tyzor AA 105 (previously available from DuPont and currently available from Dorf Ketal) was then added as a catalyst to one mixture, and Tyzor 9000 (previously available from DuPont and currently available from Dorf Ketal) was added to the other mixture. Each mixture was then heated to and held at 100° C. to monitor the evolution of viscosity. The results of this example are presented in FIG. 4. As shown in FIG. 4, Tyzor 9000 increased the viscosity approximately two to three times faster than Tyzor AA 105.

In addition, testing was performed on certain pressure sensitive adhesives of the present invention. In particular, the tested adhesives were coated upon 2 mil PET films and tested for peel adhesion, shear, and loop tack. The testing was conducted in manners similar to those described in Test Methods for Pressure Sensitive Adhesives, 8th edition, PSTC #101, 16 and 107, each of which is incorporated herein in its entirety by reference, and as further described below.

90 Degree Peel:

Samples of the adhesive either directly coated on PET film or laminated to PET film from the release liner were cut into about 2.5 cm by about 15 cm test strips. The strips were rolled down on a test panel of stainless steel, HDPE or cardboard with a 2 kg rubber clad steel roller moving back and forth at a rate of about 30 cm/min. After a dwell time of 24 hours, the test strips were peeled away from the test panel in an Instron Tensile Tester at 180 degree to the test panel, i.e., folded back on itself and parallel to the surface of the panel, at a rate of about 30 cm/min. The force to remove the adhesive strip from the test panel was measured in pounds per inch (lb/in). Tests were performed in triplicate and the average value was reported.

Shear:

Samples of the adhesive coated on PET film were laminated to a stainless steel (SS) panel using a 2 kg rubber clad steel roller with a free end of the tape extending beyond the plate. The adhesive contact area was 1.27 cm by 1.27 cm. After 20 minutes dwell at room temperature, the plate was placed at a 2° angle from the vertical and a 500 g weight was suspended from the free end. The time to failure in minutes was measured.

Loop Tack:

Loop tack measurements were made for strips that are about 25 mm (1 inch) wide using stainless steel as the substrate at a draw rate of about 50 cm/min (20 in/min), according to standard test 1994 Tag and Label Manufacturers Institute, Inc. (TLMI) Loop Tack Test L-1B2, using an Instron Universal Tester Model 4501 from Instron (Canton, Mass.). Loop tack values are taken to be the highest measured adhesion value observed during the test. The results, reported in lb/in, are reported where the substrate is stainless steel.

In particular, the foregoing testing was performed on each of the pressure sensitive adhesives prepared in Examples 9-13 and applied to a 2 mil PET film as described above. To facilitate the testing, the pressure sensitive adhesive was coated onto a 2 mil PET film and cured in an oven at 100° C. The results of those tests are shown in Table 1 below.

TABLE 1
Adhesive properties of COTA-ESO adhesives with different ratios

| | CR | | SS | | HDPE | | | |
|---|---|---|---|---|---|---|---|---|
| CW(gsm) | 15 min | 24 hr | 15 min | 24 hr | 15 min | 24 hr | Looptack | Shear |

COTA/ESO = 5.5/1 (90 degree peel)

| | | | | | | | | |
|---|---|---|---|---|---|---|---|---|
| 15.9 ± 1.9 | 0.36 ± 0.05 | 0.40 ± 0.05 | 0.67 ± 0.07 | 0.58 ± 0.01 | 0.56 ± 0.13 | 0.77 ± 0.06 | 0.61 ± 0.16 | >1,000 |

COTA/ESO = 5.4/1 (90 degree peel)

| | | | | | | | | |
|---|---|---|---|---|---|---|---|---|
| 19.4 ± 1.4 | 0.40 ± 0.07 | 0.46 ± .08 | 0.72 ± 0.05 | 0.67 ± 0.09 | 0.22 ± 0.04 | 0.38 ± 0.04 | 0.59 ± 0.34 | >1,000 |

COTA/ESO = 5.3/1 (90 degree peel)

| | | | | | | | | |
|---|---|---|---|---|---|---|---|---|
| 16.7 | 0.47 ± 0.10 | 0.61 ± 0.04 | 0.70 ± 0.03 | 0.80 ± 0.04 | 0.17 ± 0.01 | 0.29 ± 0.05 | 0.63 ± 0.09 | >1,000 |

COTA/ESO = 5.2/1 (90 degree peel)

| | | | | | | | | |
|---|---|---|---|---|---|---|---|---|
| 15.2 | 0.25 ± 0.13 | 0.34 ± 0.13 | 0.61 ± 0.12 | 0.73 ± 0.04 | 0.16 ± 0.03 | 0.31 ± 0.04 | 0.72 ± 0.16 | >1,000 |

COTA/ESO = 4.5/1 (90 degree peel)

| | | | | | | | | |
|---|---|---|---|---|---|---|---|---|
| 22.6 | off | off | 0.05 ± 0.03 | 0.13 ± 0.02 | off | off | off | >1,000 |

CR: corrugated cardboard, SS: stainless steel, HDPE: high density polyethylene, CW: coating weight

In additional testing, mixtures of COTA and ESO with different weight ratios were prepared and, in each weight ratio, various samples were prepared using different percentages of tackifier, namely Foral 85 (a synthetic glycerol ester from Pinova, Inc. of Brunswick, Ga.). The resulting mixtures were preheated in an oil bath at 100° C. The resulting viscous prepolymers were then coated onto a 2 mil PET film and further cured in oven at 100° C. as described in the earlier examples. The measured properties are listed in table 2, 3, and 4.

TABLE 2
Adhesive properties of COTA-ESO adhesives with a 4.5:1 ratio as tackified with different percentages of Foral 85
COTA/ESO = 4.5/1

| | Foral 85 | | | | | | | |
|---|---|---|---|---|---|---|---|---|
| | 40 wt % | | 30 wt % | | 20 wt % | | 10 wt % | |
| | CW(gsm) | | | | | | | |
| | 31.6 | | 26.6 | | 29.8 | | 34.1 | |
| | 15 min | 24 hrs | 15 min | 24 hrs | 15 min | 24 hrs | 15 min | 24 hrs |
| CR | 0.6 ± 0.1* | 0.7 ± 0.1* | fell off | fell off | fell off | fell off | fell off | fell off |
| SS | 1.5 ± 0.11 | 1.9 ± 0.1 | 0.36 ± 0.08 | 0.69 ± 0.17 | 0.14 ± 0.02 | 0.27 ± 0.05 | 0.13 ± 0.05 | 0.24 ± 0.09 |
| HDPE | 1.0 ± 0.0 | 1.2 ± 0.0 | 0.15 ± 0.02 | 0.22 ± 0.03 | fell off | fell off | fell off | fell off |
| GLASS | 1.5 ± 0.1 | 1.8 ± 0.1 | 0.40 ± 0.104 | 0.63 ± 0.01 | 0.10 ± 0.01 | 0.20 ± 0.03 | 0.10 ± 0.01 | 0.17 ± 0.01 |

| | |
|---|---|
| SHEAR | >30K |

| | | | | |
|---|---|---|---|---|
| Loop | 1.4 ± 0.2 (FP) | 0.02 ± 0.01 | 0 | 0 |

*CS: cardboard split (indicates that adhesion force is no less than the strength of the cardboard)
CW: coating weight; HP: heavy fiber pickup; FP: fiber pickup

TABLE 3
Adhesive properties of COTA-ESO adhesives with a 4:1 ratio as tackified with different percentages of Foral 85
COTA/ESO = 4/1

| | Foral 85 | | | | | | | |
|---|---|---|---|---|---|---|---|---|
| | 40 wt % | | 30 wt % | | 20 wt % | | 10 wt % | |
| | CW (gsm) | | | | | | | |
| | 53.2 | | 20.4 | | 45.6 | | 17.8 | |
| | 15 min | 24 hrs | 15 min | 24 hrs | 15 min | 24 hrs | 15 min | 24 hrs |
| CR | 0.8 ± 0.1* | 0.8 ± 0.1* | 0.6 ± 0.2 | 0.8 ± 0.2* | fell off | fell off | fell off | fell off |
| SS | 2.4 ± 0.23 | 2.7 ± 0.2 | 1.4 ± 0.2 | 1.9 ± 0.1 | 0.4 ± 0.0 | 0.6 ± 0.0 | 0.08 ± 0.01 | 0.20 ± 0.02 |
| HDPE | 2.1 ± 0.1 | 2.2 ± 0.0 | 0.6 ± 0.0 | 0.7 ± 0.0 | 0.2 ± 0.0 | 0.2 ± 0.0 | 0.03 ± 0.01 | 0.04 ± 0.01 |
| GLASS | 2.6 ± 0.1 | 2.8 ± 0.1 | 1.4 ± 0.1 | 1.8 ± 0.2 | 0.4 ± 0.0 | 0.5 ± 0.0 | 0.08 ± 0.02 | 0.12 ± 0.01 |

| | |
|---|---|
| SHEAR | >30K |

| | | | | |
|---|---|---|---|---|
| Loop | 2.4 ± 0.5 (HP) | 0.8 ± 0.1 | 0 | 0 |

*CS: cardboard split
CW: coating weight; HP: heavy fiber pickup; FP: fiber pickup

TABLE 4
Adhesive properties of COTA-ESO adhesives with different ratios as tackified with 40 wt % of Foral 85
Foral 85: 40 wt % of total weight

| | COTA/ESO | | | | | | | |
|---|---|---|---|---|---|---|---|---|
| | 4/1 | | 3/1 | | 2/1 | | 1/1 | |
| | CW (gsm) | | | | | | | |
| | 53.2 | | 48.4 | | 21.9 | | 49.6 | |
| | 15 min | 24 hrs | 15 min | 24 hrs | 15 min | 24 hrs | 15 min | 24 hrs |
| CR | 0.8 ± 0.1* | 0.8 ± 0.1* | 0.19 ± 0.03 | 0.22 ± 0.03 | fell off | fell off | 0.27 ± 0.01 | 0.23 ± 0.01 |
| SS | 2.4 ± 0.23 | 2.7 ± 0.2 | 1.2 ± 0.1 | 1.6 ± 0.0 | 0.58 ± 0.03 | 0.96 ± 0.11 | 0.95 ± 0.05 | 1.26 ± 0.07 |
| HDPE | 2.1 ± 0.1 | 2.2 ± 0.0 | 0.41 ± 0.05 | 0.58 ± 0.02 | 0.30 ± 0.05 | 0.36 ± 0.06 | 0.61 ± 0.03 | 0.68 ± 0.03 |
| GLASS | 2.6 ± 0.1 | 2.8 ± 0.1 | 1.2 ± 0.2 | 1.4 ± 0.2 | 0.62 ± 0.06 | 0.81 ± 0.08 | 0.97 ± 0.16 | 1.17 ± 0.16 |

| | |
|---|---|
| SHEAR | >30K |

| | | | | |
|---|---|---|---|---|
| Loop | 2.4 ± 0.5 (HP) | 0.20 ± 0.31 | 0 | 0 |

*CS: cardboard split
CW: coating weight; HP: heavy fiber pickup; FP: fiber pickup

As illustrated by the foregoing exemplary preparations, some pressure sensitive adhesive embodiments of the present invention may have a biocontent between about 20% to about 100% by weight, including each intermittent value therein. In other embodiments, pressure sensitive adhesives may have a biocontent between about 50% and about 100% by weight.

In addition to the previously-discussed procedures, the various inventive pressure sensitive adhesives of the present invention may be formed using an array of polymerization techniques. For example, the reactions can proceed by several techniques such as, but not limited to, bulk polymerization, solvent polymerization, web polymerization, or any combinations thereof. It is also contemplated that combinations of these techniques may be employed. In a bulk polymerization method, mass polymerization is performed by increasing temperature and optionally adding one or more soluble initiators to the epoxidized natural fats or oils in a liquid state. The pressure sensitive adhesives may also be formed using web polymerization techniques, in which a pressure sensitive adhesive precursor, a relatively viscous reaction mixture, is initially formed and then deposited on a web or other member where the reaction is allowed or otherwise promoted to proceed to produce the desired pressure sensitive adhesive. It is also contemplated that one or more of the foregoing techniques may utilize photocatalytic cationic polymerization to achieve the desired polymeric product(s). In addition, the reaction may be a batch reaction, fed batch reaction, or continuous reaction.

For certain applications and/or polymerization techniques, the multifunctional component(s) may constitute the majority of the starting material. As previously noted, one or more monofunctional agents may be added to control or otherwise adjust the crosslink density. If, however, an excess amount of multifunctional components are used in solvent-based polymerization at high concentrations, gelation may occur, resulting in insoluble materials that are not easily coatable and generally not suitable for pressure sensitive adhesives. Therefore, in some embodiments, multifunctional components may constitute a minority proportion of the starting material. The particular proportions utilized for the multifunctional components and other components used in the reaction systems depends upon an array of factors including, but not limited to, the number of functional groups and the molecular weight of the constituents.

As indicated above, the reagents in some embodiments of the invention may be partially polymerized to form a pressure sensitive adhesive precursor. The pressure sensitive adhesive precursor may then be transferred to a web, line, or other receiving surface. Once appropriately deposited or otherwise applied to a surface or component of interest, the pressure sensitive adhesive precursor may be subjected to further polymerization to obtain the inventive pressure sensitive adhesive.

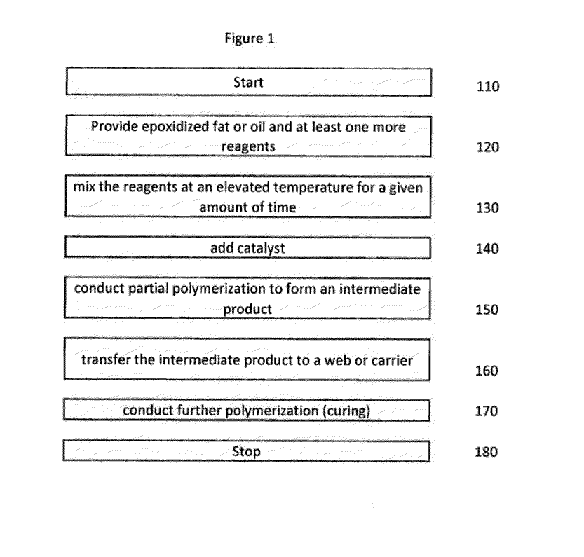

FIG. 1 is a flow chart illustrating an exemplary process involving a pressure sensitive adhesive precursor. The process starts at step 110. At step 120, one or more epoxidized fat or oil and at least one more reagent, such as a triacid, are provided. The reagents are mixed at an elevated temperature for a given amount of time at step 130. Optionally, catalysts are added at step 140, although in alternative embodiments a catalyst may be added simultaneously or nearly simultaneously with the reagents. At step 150, the reagents are allowed to partially polymerize at the elevated temperature for a given amount of time. The partial polymerization can be transitioned to the next step when a flowable pressure sensitive adhesive precursor having a viscosity that is appropriate for applying the material as a coating on a web is formed. The appropriate viscosity may be from a few centipoises (cP) to thousands of poises at the coating condition, depending on the method of application. Another parameter that can be used to indicate the end of this partial polymerization is percent gel. The percent gel is 0 at the beginning of the reaction. When the value reaches to a low level, for example, about 1%, the partially polymerized material may be transferred to the next step. Partial polymerization may be performed by exposing the reaction mixture to an appropriate amount of heat and/or radiation. At step 160, the PSA precursor is transferred to a web or other suitable carrier. One exemplary transfer method is through coating. The suitable carrier can be a release liner, a facestock, paper or polymeric film. At step 170, further polymerization is performed such as by exposure to additional heat and/or radiation. The process stops at step 180. Thus, the invention includes combinations of operations such as an initial polymerization of components with bulk polymerization to obtain a desired viscosity of the system, followed by application of the intermediate, partially polymerized product onto a surface of interest, followed by further polymerization of the product with web polymerization while on the surface of interest. In alternative embodiments, the polymerization may be completed in the reaction vessel.

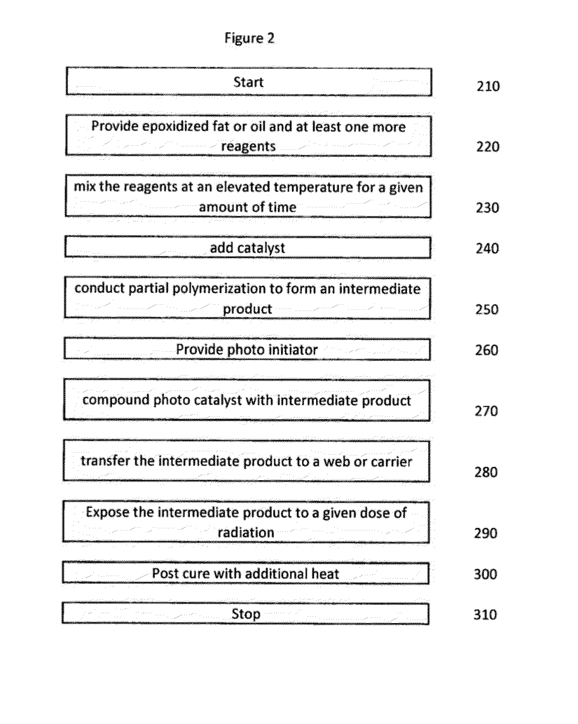

In one embodiment of the invention, thermal polymerization is used for the initial in-reactor phase of polymerization to make pressure sensitive adhesive precursors. Radiation curing followed by heat treatment may then be used for the on web polymerization and curing. FIG. 2 is a flow chart further illustrating an example of such a process. The process starts at step 210. At step 220, the epoxidized fat or oil and at least one more reagents, such as triacids, are provided. The reagents are mixed at an elevated temperature for a given amount of time at step 230. Optionally, catalysts are added at step 240, although in alternative embodiments a catalyst may be added simultaneously or nearly simultaneously with the reagents. At step 250, the reagents are allowed to partially polymerize at the elevated temperature for a given amount of time to form a pressure sensitive adhesive precursor. A photo initiator may be provided at step 260, followed by compounding the photo initiator with the PSA precursor at step 270. The photo initiators can be photoacids, photobases, or other suitable species. At step 280, the PSA precursor may be transferred to a web or other suitable carrier. At step 290, further polymerization is performed by exposure to radiation source at a given dose. UV is an exemplary, but non-limiting, radiation source for such purpose. At step 300, the sample is post cured by exposure to additional heat at a given time. The process stops at step 310.

In additional embodiments, adhesives of the present invention may be cured by incorporating reagents with vinyl, acrylic or methacrylic functional groups during the polymerization of epoxidized fats or oils and the dimer acid or diacid. The acrylic functional groups may be incorporated onto the polymer by reacting acid containing acrylic monomers such as acrylic acid or methacrylic acid, or by reacting hydroxyl containing acrylic monomers such as hydroyxethylacrylate or hydroxyethylmethacrylate, or by reacting epoxy containing acrylic monomers such as glycidylmethacrylate. Once the acrylic functionality is available on the epoxidized fats or oils and dimer acid/diacid polymer, it may be formulated with multifunctional acrylates such as hexanedioldiacrylate and UV photoinitiators such as benzophenone, and coated on release or facestock and then cured via UV radiation.

Other delivery mechanisms for the adhesives, such as water, may be incorporated. In such embodiments, the precursor may be dispered into water to form a suspension, such as by inverting the oil (the adhesive) in water. A small amount of water is added to the pressure sensitive adhesive (<10%) and dispersed in the resin using a high-torque mixer. Other additives, such as, by way of example, acetone, base, and/or surfactant, may also be added. More water/surfactant mixture would be added all at once and the water should be at the resin temperature to cause the system to flip into a continuous water phase with suspended oil, i.e., a pressure sensitive adhesive phase. As would be appreciated by one of ordinary skill in the art, this procedure is a known process for creating suspension polymers. The adhesive could be coated as an emulsion polymer onto release liner, using oven driving to form the pressure sensitive adhesive film. In some embodiments, catalysts may be added to the suspension prior to coating to aid in the final thermal cure of the polymer.

Another means of preparing these products may include a mini-emulsion polymerization process. In such a process, the starting reactants are emulsified using energy (such as sonification) to form mini-reactors. The polymerization is then carried out in the droplet and the resultant emulsion is coated as described above. In some embodiments, catalysts may be added to the system prior to coating to enhance the cure of the material.

Furthermore, pressure sensitive adhesives according to the invention may be used for any purposes. By way of example, the inventive pressure sensitive adhesives may be used as removable or permanent adhesives on paper or film facestocks, optionally with a release liner, in a variety of applications ranging from general purpose labels, office product labels, industrial tapes, and medical applications. In some embodiments, pressure sensitive adhesives of the present invention may be applied to a release liner. The pressure sensitive adhesives of the present invention may also be applied to tapes, such as transfer tapes and self-wound tapes. The facestock may be paper, coated paper, foam, polymer film, clear, opaque, translucent or metalized plastic film, metalized paper, paper backed foil, metal foil, woven, non-woven, fabric, reinforced materials and recycled paper. In some embodiments, the facestock may be formed from bio-based polymers. The substrate to be labeled may be, by way of example, a bottle, a can, a container, a vessel, a bag, a pouch, an envelope, a parcel, a box, or a cardboard box. The bio-based pressure sensitive adhesives may cover the full face of the facestock or may be pattern coated. The bio-based pressure sensitive adhesives may also be used in combination with pressure sensitive adhesives derived from petroleum based resources to achieve desired properties or cost savings. Non-limiting exemplary configurations include multilayer pressure sensitive adhesives with bio-based pressure sensitive adhesives as one of the layers, or pattern coated pressure sensitive adhesives with bio-based pressure sensitive adhesives as one of the pattern forming pressure sensitive adhesives.

These and other modifications and variations to the present invention may be practiced by those of ordinary skill in the art without departing from the spirit and scope of the present invention, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the invention as further described in such appended claims. Therefore, the spirit and scope of the appended claims should not be limited to the exemplary description of the versions contained herein.

What is claimed is:

1. A method comprising:
combining one or more epoxidized naturally-occurring oils or fats with at least one triacid to form a reaction mixture, and
applying heat to the reaction mixture to form pressure sensitive adhesive.

2. The method of claim 1 wherein the naturally occurring oil or fat is selected from one or more of soybean oil, palm oil, olive oil, corn oil, canola oil, linseed oil, rapeseed oil, castor oil, coconut oil, cottonseed oil, palm kernel oil, rice bran oil, safflower oil, sesame oil, sunflower oil, tall oil, lard, tallow, fish oil and fats or oils from algae.

3. The method of claim 1, further comprising adding a catalyst to the reaction mixture, wherein the catalyst comprises a compound selected from the group consisting of amines, imidazoles, phenols, and metal complexes.

4. The method of claim 3 wherein the catalysts are selected from the group consisting of dimethyl benzyl amine, triethylamine, triethanolamine, 2-ethyl-4-methylimidazole, 2,4,6-tris(dimethylaminomethyl)phenol, and chromium acetylacetonate.

5. The method of claim 3 wherein the reaction mixture comprises a weight ratio of triacids to epoxidized naturally-occurring oils and fats in the range of about 1:1 to about 5.5:1.

6. The method of claim 5 wherein the reaction mixture comprises a weight ratio of triacids to epoxidized naturally-occurring oils and fats in the range of about 3.5:1 to about 5.0:1.

7. The method of claim 5 wherein the reaction mixture comprises a weight ratio of triacids to epoxidized naturally-occurring oils and fats of about 4.5:1.

8. The method of claim 1 wherein the reaction mixture is heated at a temperature in the range of about 60° C. to about 120° C.

9. The method of claim 8 wherein the reaction mixture is heated between about 30 and about 60 minutes.

10. The method claim 1 further comprising forming the triacid by the steps comprising:
mixing a naturally-occurring oil or fat having at least three hydroxyl groups with an anhydride to form an acid formation mixture, and
heating the acid formation mixture to form a triacid.

11. The method of claim 10 wherein the acid formation mixture is prepared by mixing a molar ratio of triacid to naturally-occurring oil in the range of about 2.5:1 to about 3:1.

12. The method of claim 11 wherein the acid formation mixture is heated at a temperature between room temperature and about 200° C. from about 2 to about 72 hours.

13. The method of claim 11 wherein the triacid has a functionality of about 2.0 to about 3.0.

14. The method of claims 11 wherein the triacid is castor oil triacid.

15. The method of claim 11 wherein the naturally-occurring oil or fat having at least three hydroxyl groups is castor oil and the anhydride is maleic anhydride.

16. The method of claim 11 wherein the pressure sensitive adhesive has a biocontent between about 20 wt % and about 100 wt %.

17. The method of claim 1 further comprising adding at least one enhancer selected from crosslinkers, catalyst, co-initiators, tackifiers, UV absorber, enhancer, and sensitizers to the reaction mixture.

18. The method of claim 17 wherein the enhancer is selected from one or more of methyltriethoxysilane, tetraethyl orthosilicate, 1,4-cyclohexanedimethanol diglycidyl ether, pentaerythritol, tetra(ethylene glycol dimethyl ether), acetophenone, benzophenone, and anthracene.

19. The method of claim 1 wherein the method further comprises the step of applying the pressure sensitive adhesive to a facestock.

20. A pressure sensitive adhesive label or tape, comprising:
a facestock comprising an upper face and a lower face; and
one or more layers of adhesive disposed on the lower face of the facestock; wherein at least a portion of one layer of the adhesive comprises a compound made by reacting one or more epoxidized naturally-occurring oils or fats with at least one triacid.

21. A method for forming a triacid, wherein the method comprises
mixing a naturally-occurring oil or fat having at least three hydroxyl groups with an anhydride to form an acid formation mixture, and
heating the acid formation mixture to form a triacid.

22. The method of claim 21 wherein the acid formation mixture is prepared by mixing triacid and naturally-occurring oil at a molar ratio of about 2.5:1 to about 3:1.

23. The method of claim 22 wherein the acid formation mixture is heated at a temperature between room temperature and about 200° C. from about 2 to about 72 hours.

24. The method of claim 23 wherein the triacid has a functionality of about 2.0 to about 3.0.

25. The method of claim 24 wherein the triacid is castor oil triacid.

26. The method of claim 24 wherein the castor oil triacid is prepared by reacting a mixture of castor oil and an anhydride.

27. The method of claim 26 wherein the anhydride is maleic anhydride.
